(19) United States
(12) Patent Application Publication
(10) Pub. No.: US 2025/0275017 A1
(43) Pub. Date: Aug. 28, 2025

(54) Electrical Heating Device

(71) Applicant: Eberspächer catem GmbH & Co. KG, Herxheim (DE)

(72) Inventors: Patrick Werner, Neuhofen (DE); Simon Stuppert, Berg (DE)

(21) Appl. No.: 19/059,432

(22) Filed: Feb. 21, 2025

(30) Foreign Application Priority Data
Feb. 23, 2024 (DE) 10 2024 105 184.1

(51) Int. Cl. H05B 3/06; B01D 53/22; B01D 53/26; B01D 69/02; B01D 71/36

(52) U.S. Cl. CPC H05B 3/06; B01D 53/228; B01D 53/268; B01D 69/02; B01D 71/36; B01D 2257/80; B01D 2258/06; B01D 2325/04; H05B 2203/02

(57) ABSTRACT

An electrical heating device, usable in a motor vehicle, has a housing enclosing a heating chamber coupled in a heat-conducting manner to an electrical resistance element. The housing encloses a control device which can make contact on the outside of the housing via a plug housing penetrated by at least one contact element. A frame element forms a pass-through opening for the plug housing. The pass-through opening is connected in a sealed manner to the housing and has a pressure equalizer for equalizing a pressure difference between the interior of the housing and the environment of the housing. The plug housing is sealingly received in the frame element.

### BACKGROUND OF THE INVENTION

### 1. Filed of the Invention

The present invention relates to an electrical heating device.

### 2. Discussion of the Related Art

The following is regarded as being generic: an electrical heating device as known from EP 3 334 242 A1.

In the aforementioned state of the art, the electric heating device has a control housing that is connected to corresponding interfaces for plug-in contact with contact elements for the power current and for plug-in contact with contact elements for control signals. These interfaces also allow a gas exchange between the interior of the housing and the environment and thus a pressure equalization.

On this basis, the present invention is intended to provide an electric heating device that can be adapted to different requirements in an improved manner.

### SUMMARY

To solve this problem, the present invention proposes an electric heating device that is usable in a motor vehicle and that includes a housing enclosing a heating chamber coupled in a heat-conducting manner to an electric resistance element, the housing enclosing a control device which is capable of being connected by a plug on an outside of the housing. A frame element forms a pass-through opening for the plug housing. A guide element is accommodated in the frame element. The frame element is connected to the housing in a sealed manner. The frame element extends beyond the housing on the outside and is used for the sealing connection of a plug element, which is usually connected to a cable for the power current and/or control signals and has plug contact elements that are electrically connected to the control device inside the housing by plug-in contact. The guide element is connected to the printed circuit board. The guide element may be made of plastic. The contact elements may be integrated into the guide element.

As part of the plug-in connection, the plug element is usually mechanically connected to the frame element and in the process, a pass-through opening left free inside the frame element is sealed against the environment. This can prevent pressure equalization between the plug element and the frame element, which carries the risk that moisture carried by the plug during pressure equalization can transfer charge carriers to the cable and thus to downstream components of the vehicle, for which the heating device according to the invention is designed in particular.

Rather, the pressure equalization device is formed by a component that is connected to the housing but has no electrical function. The frame element can thus be designed independently of the specific design of the plug housing, in particular the contact elements that are usually provided in multiple form therein. The guide element connected to the printed circuit board can be adapted to individual customer requirements, whereas a universally designed frame element can be used for different heating devices and their housings or plug housings to be connected. The guide element and the pass-through opening provided on the frame need only be designed to correspond with each other. The guide surfaces on the guide element can each be adapted to customer requirements.

Furthermore, the guide element is to be connected directly to a printed circuit board, in particular a populated one, which usually forms the essential part of the control unit. The guide element is then attached to the printed circuit board. In this case, an electrical contact of the at least one contact element for the plug-in contact with a conductor track of the printed circuit board may be carried out directly. The guide element also guides the printed circuit board and can be supported within the housing in the direction of the plug-in contact, so that the force acting in the context of the plug-in contact does not have to be carried directly by the printed circuit board, but can be transferred to the housing. This increases the service life of the printed circuit board. The electrical contacts are also located within the guide element and thus within the housing, reducing the overall height of the electrical heating device compared to the prior art, in which the plug housing together with the plug contacts is exposed on the outside of the housing.

A pressure equalization channel may be provided as a pressure equalization device on the frame element. This generally extends parallel to, but adjacent to, the pass-through opening for the electrical contact.

A means for retaining moisture, in particular water in the liquid state or vapor form, may be integrated in the pressure equalization channel. This can be formed from metal or plastic, in particular as a membrane that provides different permeability for gases and moisture. Such properties can also be provided by filters made of plastic, natural materials such as cellulose fibers and/or metal.

The means may be provided on an inside of the frame element facing the sealed interior. The means also generally prevents the passage of dirt through the pressure equalization channel.

According to an embodiment of the present invention, the frame element is a component manufactured by plastic injection molding. The pressure equalization channel may be provided on this injection molding as a tooling step (off-tool). This allows the frame element to be produced economically. The pressure equalization channel can also be formed by a separate component such as a dust cap or a protective clip and connected to the frame element. According to a possible further development, the pressure equalization channel is closed by a membrane. This can be flexible in order to compensate for certain pressure fluctuations within the control housing by elastic deformation. However, the membrane may be permeable to air and impermeable to water, so that in the event of excess pressure, air can escape from the control housing or, in the event of a certain vacuum, air can flow into the control housing through the membrane, so that pressure equalization is effected within the control housing. For venting, simple systems that have only one membrane can be used, or multi-part systems that have a multilayer film structure, where different layers of the film structure can have various functions, such as a mechanical function or a retaining function. A ready-made ventilation pin, similar to a screw, can also be inserted into the pressure equalization channel to allow ventilation. A filter can also be used in the context of the invention for ventilation or venting through the pressure equalization channel. The said membrane can be welded to the frame element, in particular ultrasonically welded. Alternatively or additionally, the membrane or a component having the pressure equalization channel and/or the at least one membrane can be adhesively bonded to the frame element.

It has been found that a membrane that is permeable to air but impermeable to liquid may be formed from ePTFE or PTFE. This membrane should have a thickness between 120 μm and 240 μm, in particular 180 μm +/−50 μm. Practical tests by the applicant have shown that such a membrane prevents the entry of water or water vapor into the control housing, but allows air to escape from the control housing through the membrane.

### BRIEF DESCRIPTION OF THE DRAWINGS

Further details and advantages of the present invention will become apparent from the following description of an embodiment in conjunction with the drawing. The drawings show:

FIG. 1: a perspective exploded view of an embodiment of the present invention.

FIG. 2: a perspective view of a printed circuit board;

FIG. 3: a perspective view of a frame element

FIG. 4: a perspective view of a frame element without a membrane;

FIG. 5: a longitudinal sectional view through the frame and guide elements;

FIG. 6: a cross-sectional view rotated through 90° with respect to FIG. 5, and

FIG. 7: a cross-sectional view rotated through 90° with respect to FIG. 5, through the pressure equalization channel.

### DETAILED DESCRIPTION

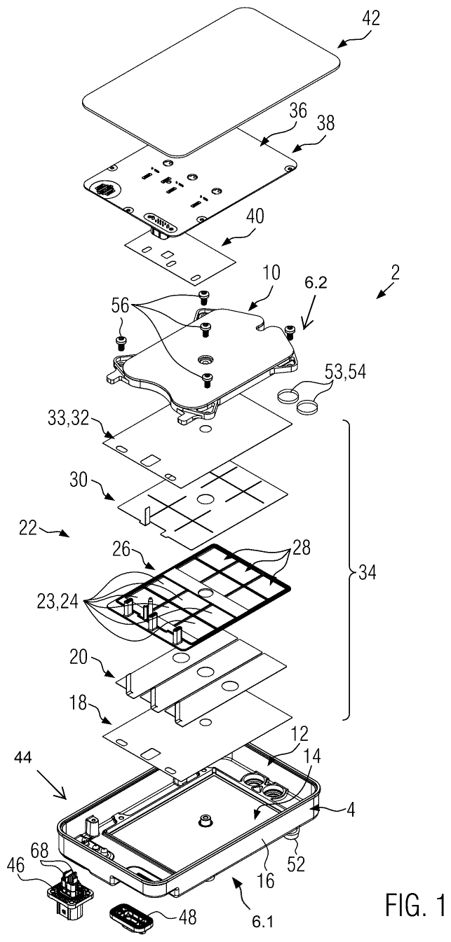

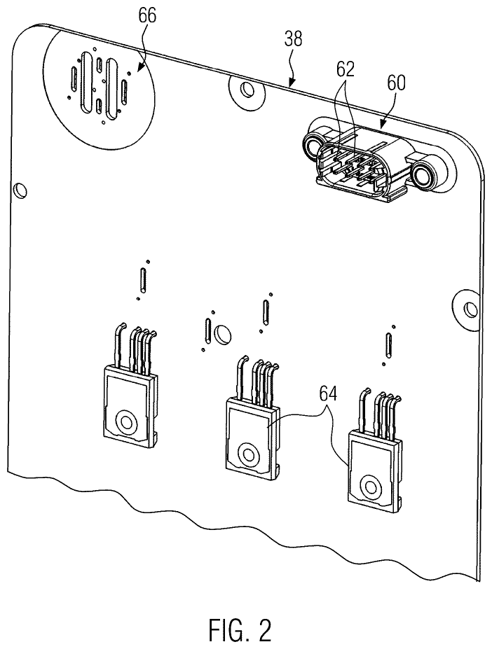

FIG. 1 shows an electric heating device 2 with a housing base part 4, which is connected on its lower side in FIG. 1 to a heating chamber cover, not shown here, to form a first heating chamber 6.1—see FIG. 2. Reference sign 10 denotes a fluid housing that is accommodated in a receiving space 12 formed by the housing base part 4 and forms a second heating chamber 6.2. In this receiving space 12, which is bounded at the bottom by a base 14 and at the edge by a peripheral wall 16 extending from the base 14, and between the base 14 and the fluid housing 10, there is a first insulating layer 18, which can be placed against the base 1 4, a first contact layer 20 and a heating means 22 having a multiplicity of electrical resistance elements 23, in the present case in the form of PTC elements 24, and a positioning frame 26 having receptacles 28 for receiving the PTC elements 24.

On the side of the heating means 22 opposite the first contact-making layer 20, a second contact-making layer 30 is provided, on the side of which opposite the heating means 22 a second insulating layer 32 is arranged. The PTC elements are therefore in electrically conductive contact with the contact-making layers 20, 30 and are energized via these. The PTC elements 24 are ceramic cuboid components that are provided with a metallization on opposite main side surfaces for the introduction of current. The main side surface is the surface of the cuboid with the greatest areal extent. The main side surfaces are connected to one another by edge surfaces, which predetermine the height of the PTC elements and have no metallization. The main side surfaces are each larger than one of the edge surfaces by a factor of 5, typically larger than the sum of all the edge surfaces.

The second insulating layer 32 is formed as a prestressing device 33 by a silicone film which is capable of absorbing certain compressions by elastic deformation and thus of placing the electric heating means 22 between the housing base part 10 and the housing bottom 14 under prestressing against the housing base part 10 and the housing bottom 14.

The layering of the first insulating layer 18, the first contact-making layer 20, the heating device 21, the second contact-making layer 30 and the second insulating layer 32 is also referred to below as the layered structure 34.

On the side of the fluid housing 10 facing away from this layered structure 34 in the embodiment shown, there is a transistor insulation 40 between a printed circuit board 38 forming a control device 36 and the fluid housing 10. Reference sign 42 denotes a housing cover which is connected to the housing base part 4 to form a housing, which is designated by reference sign 44. The housing base part 4 and the housing cover 42, and possibly further housing parts, are designed to be shielding, i.e. made of metal and/or provided with a separate shielding on the inside, outside or in the walls, which may be made of plastic, of the respective housing part. Aluminum is used as the metallic material, or stainless steel is used regarding corrosion resistance.

On the underside of the base part of the housing 4, opposite the housing cover 42, a power plug 46 and a control plug 48 are shown in FIG. 1. These two connectors 46, 48 are connected to the housing base part 4 in a sealed manner and have various male electrical plug contacts, which are passed in a sealed manner through the respective housings of the connectors 46, 48 and are plug-contacted in the printed circuit board 38 and are electrically connected via this plug-contacting to conductor tracks of the printed circuit board 38. Details will be described below in connection with FIG. 4. For the plug-in contact, the printed circuit board 38 has female contact tongue receptacles, which are described in EP 2 236 330 A1.

Furthermore, inlet and outlet connectors 50, 52 for connecting pipes or hoses that carry the fluid to be heated are provided on the underside. Reference sign 53 designates the sealing arrangement 53 shown in FIG. 1 below the fluid housing 10, which in the present case is formed by two sealing rings 54. Reference sign 56 denotes screws for fixing the fluid housing 10 with respect to the housing base part 4 with the interposition of the layered structure 34. By means of this screw connection, the layers of the layered structure 34 are applied under prestress against the fluid housing 10 and the bottom 14 of the housing base part 4.

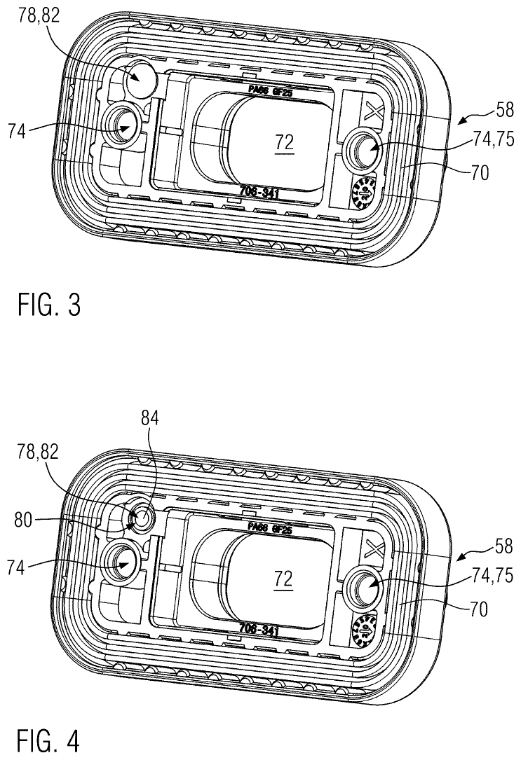

As the details of FIGS. 2 and 3 show, the control connector 48 consists of a frame element 58 and a guide element 60 that is directly mechanically connected to the printed circuit board 38. Contact elements marked with reference sign 62 pass through the guide element 60 in a sealed manner, in that these contact elements 62 are encapsulated, in particular injection molded, by the plastic material forming the guide element 60. The contact elements 62 are directly electrically contacted with conductor tracks of the printed circuit board 38. Reference sign 64 designates various components of the assembled printed circuit board 38. Reference sign 66 designates a power plug contact for high voltage, which is formed on the printed circuit board 38, and connects contact elements 68 of the power plug 46 electrically to conductor tracks of the printed circuit board 38, which can be seen in FIG. 1.

FIG. 3 shows details of the frame element 58 in a perspective bottom view. This has a peripheral seal 70 and connecting sleeves 74 provided in the extension of an elongated pass-through opening 72 for receiving screws, not shown in the drawing, which press the frame element 58 against an outer surface of the housing 44, with the seal 70 bearing against it. Adjacent to the connecting sleeve 74 shown on the left in FIG. 3, a membrane 76 is marked, which, as an air-permeable but water-impermeable means 75, seals a pressure equalization channel to the receiving space of the housing 44, which channel is marked with reference sign 78 in FIG. 4. The membrane 76 is firmly connected to a surrounding collar 80, in particular by means of ultrasonic welding, which surrounds the inside opening of the pressure equalization channel 78 in FIG. 4 and projects with respect to the inner surface of the frame element 58. The membrane 76 and the pressure equalization channel 78 form a pressure equalization device 80. The pressure equalization channel forms a pressure equalizing device, generally denoted 82.

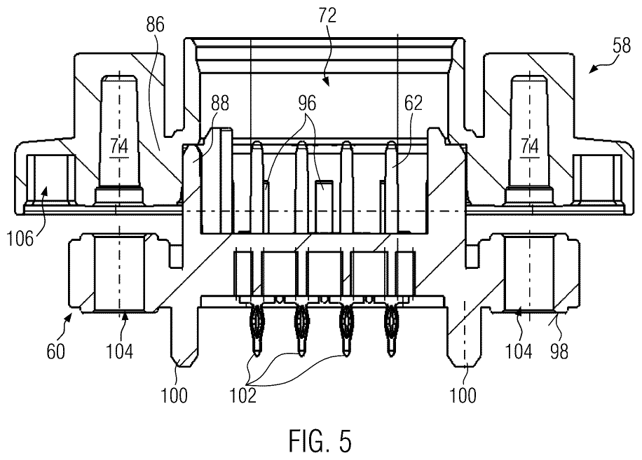

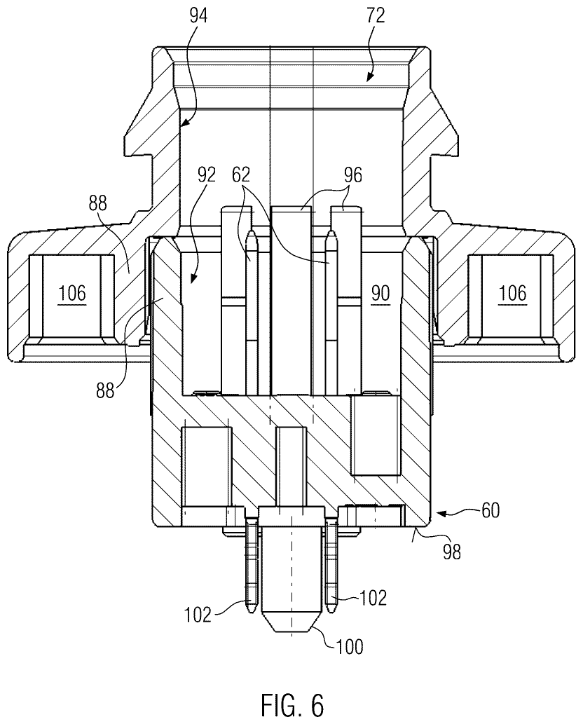

FIG. 4 also illustrates a cover 84 for the pressure equalization channel 78, which is formed on the frame element 58, which is produced by injection molding, in an off-tool manner and initially covers the pressure equalization channel 78. Optionally, this cover 84 can be pierced during further processing of the injection- molded frame element 58 to expose the pressure equalization channel 78 on the front side. The cover 84 can also permanently cover the equalization channel 78 for another variant and prevent the passage of air or moisture. In the embodiment shown, the membrane 76 consists of ePTFE. In the present case, it is a product with a thickness of 180 μm. This membrane allows air to pass through but prevents the passage of moisture or liquid contained in the air. FIGS. 5 and 6 show sectional views of the frame element 58 and the guide element 60 after joining. The frame element 58 forms a collar 86 which, in the joining direction of the two components, at least partially covers a guide sleeve marked with reference sign 88. As a result, the connecting sleeve 74 of the frame element 58 is aligned with a contacting space of the guide element 60 marked with reference sign 90. In other words, the wall surfaces 92 of the guide element 60, which bound the contact-making space 90, are aligned with the cylindrical surfaces 94 of the frame element 58. Guide ribs 96, which can be seen in FIGS. 5 and 6, project from the wall surfaces 92, which, in the context of the plugging movement, interact with associated guide surfaces of a housing of a plug element not shown and enforce a one-to-one alignment of plug element and frame element 58 for the electrical plug connection and thus bring about a poka-yoke function. This plugging movement extends parallel to the longitudinal extension of the contact elements 62, which can be seen in FIGS. 5 and 6.

On its underside, the guide element 60 forms a flat contact surface 98 for contact with the printed circuit board 38, which is formed by positioning pegs 100 of different diameters, which, with a view to a Poka-Yoke function, interact with correspondingly sized holes of different sizes, adapted in diameter, within the printed circuit board 38 for positioning the guide element 60 during assembly and for holding it after assembly, and engage therein, and by contacting pins 102 holes within the printed circuit board 38 for the positioning of the guide element 60 during assembly and for its retention after assembly, and contact pins 102 project above it, which are connected in an electrically conductive manner to conductor tracks of the printed circuit board 38.

In FIG. 5, these elements are each bounded by a through-hole 104 recessed in the guide element 60. The through-holes 104 are each aligned with their associated connecting sleeves 74, which are closed to the outside of the housing 44 by the material forming the frame element 58. The connecting sleeves 74 receive fastening means, for example screws, which pass through a hole on the printed circuit board 38, the through-holes 104 and the housing 44 and are finally threadedly engaged in the connecting sleeve 74. After assembly, the free ends of the positioning lugs 100 can be supported on an inner wall of the housing 44. They thus store the force that acts within the guide element 60 when the plug-in element is plugged in. This relieves the load on the printed circuit board 38.

Finally, reference sign 106 designates the sealing groove which receives the seal 70.

The frame element 58 can be formed from metal or plastic. The guide element 60 is usually formed from plastic and receives the contact elements 62 in itself.

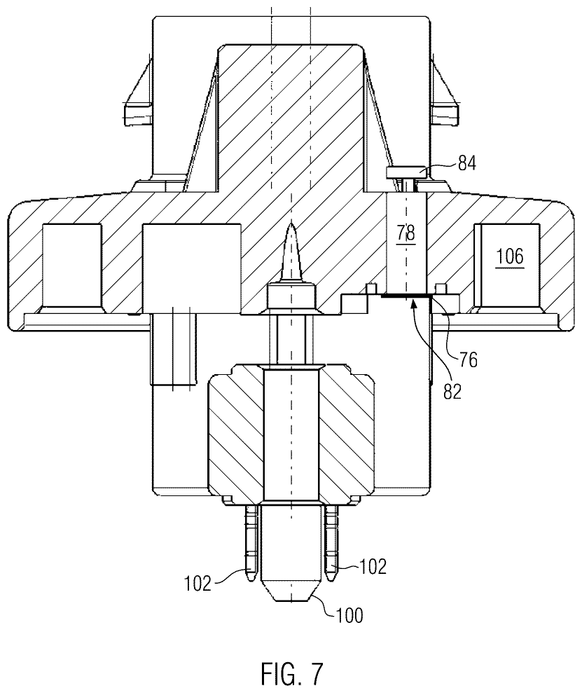

FIG. 7 shows a sectional view in a plane according to FIG. 6, but offset so that the sectional view intersects the pressure equalization channel 78. In this embodiment, a variant of FIG. 4 is realized, in which the cover 84 is provided on the outside of the frame element 58. It can be seen that this cover 84 prevents mechanical intervention in the pressure equalization channel 78. The membrane 76 is shown at the inner end of the pressure equalization channel 78 as being welded to the opening to the pressure equalization channel 78.

1. An electric heating device for a motor vehicle, comprising:
a housing enclosing a heating chamber coupled in a heat-conducting manner to an electric resistance element, the housing enclosing a control device which is capable of being connected by a plug on an outside of the housing,
a frame element which forms a pass-through opening, wherein the frame element is connected in a sealed manner to the housing and has a pressure equalizing device for equalizing a pressure difference between the interior of the housing and the environment of the housing, and in which a guide element, connected to a printed circuit board, is received in a sealed manner.

2. The electrical heating device according to claim 1, wherein the pressure equalizing device is provided on the frame element as a pressure equalization channel.

3. The electrical heating device according to claim 2, wherein the frame element is a component manufactured by plastic injection molding, and wherein the pressure equalization channel is provided on the frame element in an off-tool manner.

4. The electrical heating device according to claim 2, wherein the pressure equalization channel is closed by way of a filter device which is permeable to air but impermeable to water.

5. The electrical heating device according to claim 4, wherein the filter device comprises a membrane which is welded to the frame element.

6. The electrical heating device according to claim 4, wherein the membrane is joined to the frame element.

7. The electrical heating device according to claim 6, wherein the membrane is formed from PTFE and has a thickness of between 120 μm and 240 μm.

8. The electrical heating device according to claim 4, wherein the filter device is formed by a sinter filter.

9. The electrical heating device according to claim 1, wherein the circuit board is a printed circuit board that is equipped with components.

10. The electrical heating device according to claim 1, wherein the frame element forms a collar that projects into the housing, and wherein the guide element has a guide sleeve projecting from the printed circuit board.

11. The electrical heating device according to claim 10, wherein the collar and the guide sleeve overlap in a longitudinal direction of contact elements that are electrically connected to the control device inside the housing by plug-in contact.

12. The electrical heating device according to claim 2, further comprising a cover covering the pressure equalization channel on an outside thereof.
